(19) United States
(12) Patent Application Publication
(10) Pub. No.: US 2011/0292068 A1
(43) Pub. Date: Dec. 1, 2011

(54) IMAGE DISPLAY METHOD AND IMAGE DISPLAY APPARATUS

(75) Inventor: Masamitsu Kobayashi, Osaka-shi (JP)

(73) Assignee: Sharp Kabushiki Kaisha, Osaka-shi (JP)

(21) Appl. No.: 13/148,217

(22) PCT Filed: Nov. 25, 2009
(86) PCT No.: PCT/JP2009/006366

§ 371 Date: Aug. 5, 2011

(30) Foreign Application Priority Data
Mar. 13, 2009 (JP) 2009-061992

(51) Int. Cl. G09G 5/02; G09G 3/36; G09G 5/10

(52) U.S. Cl. 345/589; 345/690; 345/87

(57) ABSTRACT

Disclosed is a method in which a shaded image signal is obtained by carrying out a shading process based on a previous image signal and a current image signal, a weighting of the shading process is changed in accordance with a signal level of the previous image signal and that of the current image signal, and a sub frame period is provided by dividing a frame period; thereafter, the shaded image signal is outputted to the sub frame period.

### CROSS REFERENCE TO RELATED APPLICATIONS

This application is a national stage application under 35 USC 371 of International Application No. PCT/JP2009/006366, filed Nov. 25, 2009, which claims the priority of Japanese Patent Application No. 2009-61992, filed Mar. 13, 2009, the contents of both of which prior applications are incorporated herein by reference.

### FIELD OF THE INVENTION

The present invention relates to an image display method, and an image display apparatus such as a liquid crystal display apparatus.

### BACKGROUND OF THE INVENTION

With an image display apparatus using a hold-type display apparatus such as a liquid crystal display device, there is a problem that motion blur occurs.

The motion blur in a conventional hold-type display apparatus is described with reference to FIG. 19.

FIG. 19 illustrates a conventional technique, and is a view illustrating an overview of the motion blur. More specifically, FIG. 19 illustrates how display is carried out in two consecutive frames, a previous frame and a current frame, in a case where an image as illustrated in FIG. 20 moves in a horizontal direction. The image illustrated in FIG. 20 is one in which half thereof displayed on a screen is of a region having an image signal brightness level of 0% and the other half thereof is of a region having an image signal brightness level of 100%.

Moreover, FIG. 21 illustrates a brightness level distribution of image signals inputted at a time when the image illustrated in FIG. 20 is displayed, into pixels disposed on one horizontal line of the screen in the consecutive previous frame and current frame.

Illustrated in FIG. 19 is a magnification of a border part between the brightness level of 100% and the brightness level of 0% while the image signals illustrated in FIG. 20 are inputted into the pixels. As illustrated in FIG. 19, a borderline between the brightness level of 100% and the brightness level of 0% slides to the right in pixel position in the current frame period, as compared to the borderline in the previous frame period.

When an image moves in the horizontal direction as such, an observer who closely observes the screen usually follows an object which moves horizontally. Hence, the observer recognizes, as the brightness level sensed by the eye, an integrated amount of the brightness level of each frame integrated in the direction of the arrows L11 and L12 illustrated in FIG. 19.

At this time, a first region R11 which is a region on the left side of the arrow L11 in FIG. 19 is recognized as having a brightness level of 100% throughout the region, in the previous frame and the current frame.

On the other hand, a third region which is a region on the right side of the arrow L12 in FIG. 19 is recognized as having a brightness level of 0% throughout the region, in the previous frame and the current frame.

Consequently, no motion blur is recognized in the first region R11 and the third region R13.

The motion blur occurs in a second region R12, which is a region sandwiched between the arrow L11 and the arrow 12. This is because the second region R12 includes a part having the brightness level of 0% and a part having a brightness level of 100% combined in the one region, as illustrated in FIG. 19.

As a result, the observer recognizes the second region as, for example, a halftone that is neither the brightness level of 0% or 100%. More specifically, the observer recognizes a width W10 illustrated in FIG. 19 as the halftone which has neither the brightness level of 0% or 100%.

The region recognized as the halftone serves as a blur in the display (edge blur). In the case where the brightness level of 0% and the brightness level of 100% are displayed as illustrated in FIG. 19, the second region R12 which is the border part between the brightness level of 0% and the brightness level of 100% is recognized as the edge blur. Namely, in the example illustrated in FIG. 19, the width W10 is the width of the blur. This edge blur is called a motion blur caused by a hold drive (hereinafter referred to as motion blur).

(Black Insertion)

One way of reducing the motion blur is, for example, to provide a display period having a minimum brightness level (e.g., black display having a brightness level of 0%) in a portion of one frame period.

However, with this method, the entire screen repetitively switches between a bright state and a dark state per cycle of one frame. This causes a problem that the screen easily flickers.

Moreover, in a case where the brightness level of the image signal is of its maximum value (e.g., a white display having a brightness level of 100%), providing a display period having a minimum brightness level within one frame period causes the brightness level to decrease.

Patent Literature 1 proposes a method for generating an interpolating image signal, as a method for reducing the motion blur without causing the flickering.

### CITATION LIST

Japanese Patent Application Publication, Tokukaihei, No. 4-302289 A (Publication Date: Oct. 26, 1992)
Japanese Patent Application Publication, Tokukai, No. 2006-259689 A (Publication Date: Sep. 28, 2006)

### SUMMARY OF THE INVENTION

In the method disclosed in Patent Literature 1, it is necessary to accurately estimate a temporally intermediate image signal, i.e., an image signal positioned temporally intermediate between two frames. However, it is difficult to completely and accurately estimate the temporally intermediate image signal, and there are cases where an error occurs caused by misestimating the temporally intermediate image signal. This becomes a cause for deterioration in image quality, such as generation of image noise.

The following description describes a summary of the technique disclosed in Patent Literature 1, and thereafter its problems.

FIG. 22 is a view illustrating an overview of a motion blur that occurs when display is carried out in a method based on the technique disclosed in Patent Literature 1 (hereinafter referred to as “frame interpolation technique”).

Illustrated in FIG. 22 is an example of the frame interpolation technique, in which the display device is driven at 2× of the display method illustrated in FIG. 19.

In the present specification, a driving speed is not limited to 2×; 2× is only one example, and can also be 3×, 4×, or like speed. Moreover, the speed also includes ones other than integrals, such as 2.5×.

Both the previous frame and the current frame are divided into two frames: an original frame (sub frame A period) and an estimated sub frame (sub frame B period).

The image signal inputted during the sub frame B period is the interpolating image signal. More specifically, the temporally intermediate image signal 58 is inputted into the sub frame B period, as the interpolating image signal.

The temporally intermediate image signal 58 is calculated by use of a motion vector, as an image signal provided between two consecutive image signals, based on the image signals inputted into two consecutive frames.

The image signals inputted into the frames in the frame interpolation technique illustrated in FIG. 22, are specifically as described below.

Namely, an image signal inputted into the previous frame (previous image signal 50) is inputted into an original frame of the previous frame, as it is. Moreover, the temporally intermediate image signal 58 of (a) the image signal inputted into the previous frame and (b) the image signal inputted into the current frame, is inputted into an estimated sub frame of the previous frame.

In the current frame which is a subsequent frame of the previous frame, an image signal that is inputted to the current frame (current image signal 52) is inputted as it is into its original frame. Moreover, a temporally intermediate image signal 58 of (a) the image signal inputted into the current frame and (b) an image signal inputted into a subsequent frame of the current frame, is inputted into an estimated sub frame of the current frame.

The motion blur can be held down by inputting image signals as like the aforementioned image signal, while driving the display device at a speed of 2×.

Namely, the first region R21, which is a region on the left side of the arrow L21 in FIG. 22, is recognized as having a brightness level of 100% in all regions in the previous frame and the current frame.

Moreover, the third region R23, which is a region on the right side of the arrow L22 in FIG. 22, is recognized as having a brightness level of 0% in all regions in the previous frame and the current frame. Therefore, no motion blur is recognized in the first region R21 and the second region R23.

The motion blur occurs in a second region R22 which is a region sandwiched between the arrow L21 and the arrow L22. This is because the second region R22 includes a part having a brightness level of 0% and a part having a brightness level of 100% combined in the one region, as illustrated in FIG. 22.

Hence, the observer recognizes the second region for example as a halftone which has neither the brightness level of 0% or 100%.

More specifically, a width W20 illustrated in FIG. 22 is recognized as the halftone. Namely, the width W20 serves as a blur width.

A comparison of the width W10 illustrated in FIG. 19 with the width W20 illustrated in FIG. 22 reveals the fact that the width W20 is narrower.

Hence, it is observed that the motion blur is reduced in FIG. 22.

(Estimation Error)

However, with the frame interpolation technique, there are cases where it is difficult to accurately estimate the temporally intermediate image signal 58, which is the intermediate image signal between two consecutive frames. If there is an estimation error to the temporally intermediate image signal 58, the error may serve as a cause for image quality deterioration such as image noise and the like. The following describes an example of the estimation error, with reference to FIG. 23.

An example of an image signal in which an estimation error easily occurs is a case where parts having a high brightness level (high gray scale part) are successively provided, as illustrated in FIG. 23. FIG. 23 illustrates an image signal in which two high gray scale parts are provided successively; a first high gray scale part P1 and a second high gray scale part P2.

In order to estimate the temporally intermediate image signal 58 of (a) the previous image signal 50 which is the image signal of the previous frame and (b) the current image signal 52 which is the image signal of the current frame, it is required to associate the first high gray scale part P1 of the previous image signal 50 with the first high gray scale part P1 of the current image signal 52, and similarly, to associate the second high gray scale part P2 of the previous image signal 50 with the second high gray scale part P2 of the current image signal 52.

However, for example in a case where a shape of the first high gray scale part P1 is similar to that of the second high gray scale part P2, the second high gray scale part P2 of the previous image signal 50 may become associated with the first high gray scale part P1 of the current image signal 52 (see the arrow (2) in FIG. 23) by mistake, instead of the second high gray scale part P2 of the previous image signal 50 being associated with the second high gray scale part P2 of the current image signal 52 (see the arrow (1) in FIG. 23).

If the temporally intermediate image signal 58 is estimated based on such a situation (see the arrow (2) in FIG. 23), it is not possible to obtain an accurate temporally intermediate image signal 58.

Further, if an error occurs caused by an estimation error of the temporally intermediate image signal 58, this causes the image quality deterioration such as image noise and the like, as described above.

The present invention is accomplished to solve the foregoing problem, and its object is to provide an image display method and an image display apparatus, each of which is capable of holding down occurrence of the motion blur while reducing image quality deterioration caused by estimation error such as image noise, by use of a technique different from the frame interpolation technique which uses a conventional motion vector or the like.

In order to attain the object, an image display method of the present invention is a method of displaying an image on a screen in which a plurality of pixels are arranged, the image being displayed on the screen by the pixels of the screen receiving an image signal per frame period, the frame period being a period required for the pixels of one screen to receive the image signal, the method including: obtaining a shaded image signal by carrying out a shading process based on a previous image signal and a current image signal, the previous image signal being an image signal inputted into a previous frame period and the current image signal being an image signal inputted into a current frame period, the previous frame period and the current frame period being two consecutive frame periods; changing a weighting of the shading process in carrying out the shading process, in accordance with a difference between a signal level of the previous image signal and a signal level of the current image signal; dividing the previous frame period to provide a sub frame period; and outputting the shaded image signal to the sub frame period.

Moreover, in order to attain the object, an image display apparatus of the present invention includes: a screen in which a plurality of pixels are arranged, displaying an image by receiving an image signal at the pixels per frame period, the frame period being a period required for the pixels of one screen to receive an image signal; and a controller controlling the image signal, the controller (i) obtaining a shaded image signal by carrying out a shading process based on a previous image signal and a current image signal, the previous image signal being an image signal inputted into a previous frame period and the current image signal being an image signal inputted into a current frame period, the previous frame period and the current frame period being two consecutive frame periods, (ii) changing a weighting of the shading process in carrying out the shading process, in accordance with a difference between a signal level of the previous image signal and a signal level of the current image signal, (iii) dividing the previous frame period to provide a sub frame period, and (iv) outputting the shaded image signal to the sub frame period.

According to the method and the configuration, a shaded image signal to which a shading process is carried out based on a previous image signal and a current image signal is outputted to a sub frame period. This shading process is changed in weighting in the shading process, in accordance with a difference between a signal level of the previous image signal and a signal level of the current image signal.

Hence, it is possible to narrow a motion blur width occurring when the image is being followed by the eye.

Hence, according to the method and configuration, it is possible to provide an image display method and an image display apparatus, each of which is capable of holding down occurrence of a motion blur while reducing image quality deterioration such as image noise and the like caused by an estimation error in a frame interpolation technique that uses a conventional motion vector or the like.

As described above, an image display method of the present invention includes: obtaining a shaded image signal by carrying out a shading process based on a previous image signal and a current image signal, the previous image signal being an image signal inputted into a previous frame period and the current image signal being an image signal inputted into a current frame period, the previous frame period and the current frame period being two consecutive frame periods; changing a weighting of the shading process in carrying out the shading process, in accordance with a difference between a signal level of the previous image signal and a signal level of the current image signal; dividing the previous frame period to provide a sub frame period; and outputting the shaded image signal to the sub frame period.

As described above, an image display apparatus of the present invention is configured in such a manner that the controller (i) obtains a shaded image signal by carrying out a shading process based on a previous image signal and a current image signal, the previous image signal being an image signal inputted into a previous frame period and the current image signal being an image signal inputted into a current frame period, the previous frame period and the current frame period being two consecutive frame periods, (ii) changes a weighting of the shading process in carrying out the shading process, in accordance with a difference between a signal level of the previous image signal and a signal level of the current image signal, (iii) divides the previous frame period to provide a sub frame period, and (iv) outputs the shaded image signal to the sub frame period.

Hence, it is possible to yield an effect that an image display method and an image display apparatus can be provided, each of which can hold down the motion blur.

### BRIEF DESCRIPTION OF THE DRAWINGS

FIG. 1 illustrates an embodiment of the present invention, and is a view illustrating an overview of a motion blur.

FIG. 2 illustrates an embodiment of the present invention, and is a view illustrating an image signal subjected to a shading process (weighted mean filtering process).

FIG. 3 illustrates an embodiment of the present invention, and is a view illustrating a shading process filter shape.

FIG. 4 illustrates an embodiment of the present invention, and is a view illustrating a rectangular range as one example of a shading process range.

FIG. 5 illustrates an embodiment of the present invention, and is a view illustrating a round range as one example of a shading process range.

FIG. 6 illustrates an embodiment of the present invention, and is a view illustrating an oval range as one example of a shading process range.

FIG. 7 illustrates an embodiment of the present invention, and is a view illustrating a hexagonal range as one example of a shading process range.

FIG. 8 is a view illustrating a relationship between a brightness level and a gray scale level.

FIG. 9 illustrates an embodiment of the present invention, and is a view illustrating a shape of a weighted mean filtering process-subjected image signal.

FIG. 10 is a view illustrating an image signal obtained by a frame interpolation process.

FIG. 11 is a view illustrating an image signal in a case where an LPF process is carried out just to a difference part.

FIG. 12 illustrates an embodiment of the present invention, and is a view illustrating an edge shape visually confirmed when being followed by the eye.

FIG. 13 illustrates an embodiment of the present invention, and is a view schematically illustrating a configuration of an image display apparatus.

FIG. 14 illustrates another embodiment of the present invention, and is a view illustrating how an edge moves.

FIG. 15 illustrates another embodiment of the present invention, and is a view illustrating shapes of a shading process (weighted mean filtering process) image signal.

FIG. 16 illustrates another embodiment of the present invention, and is a view illustrating an edge shape visually confirmed when being followed by the eye.

FIG. 17 illustrates another embodiment of the present invention, and is a view schematically illustrating a configuration of an image display apparatus.

FIG. 18 illustrates another embodiment of the present invention, and is a view illustrating an overview of a process carried out to a difference modulus.

FIG. 19 illustrates a conventional technique, and is a view illustrating an overview of a motion blur.

FIG. 20 is a view illustrating how a region, whose image signal has a brightness level of 100%, moves in a horizontal direction on a background whose image signal has a brightness level of 0%.

FIG. 21 is a view illustrating a brightness level in a previous frame and a current frame, on one horizontal line.

FIG. 22 illustrates a conventional technique, and is a view illustrating an overview of a motion blur in a case where a sub frame of a motion vector is used.

FIG. 23 illustrates a view which explains an estimation error occurring upon obtaining a temporally intermediate image signal 58.

### DESCRIPTION OF THE INVENTION

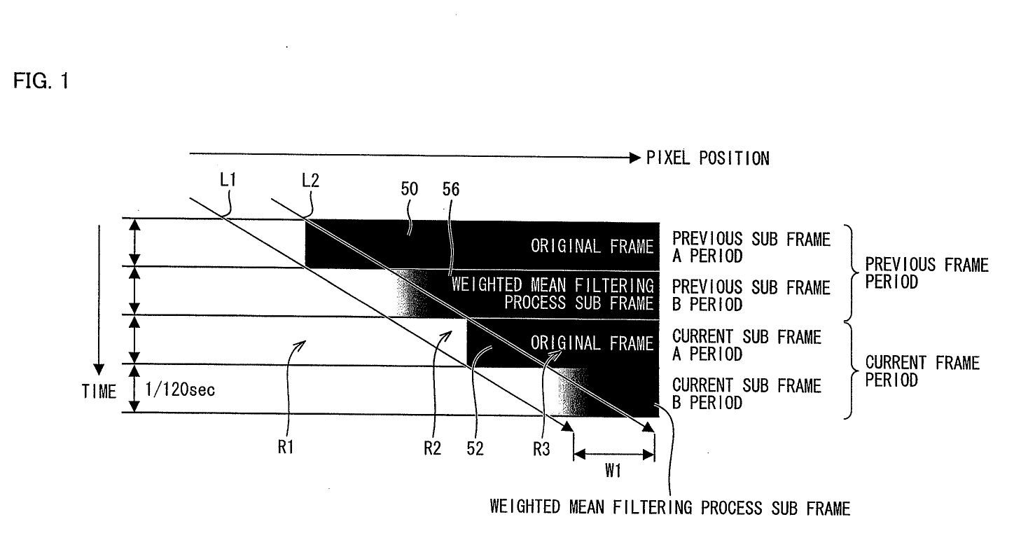

One embodiment of the present invention is described below, with reference to FIG. 1 through FIG. 13 and the like.

FIG. 1 is a view illustrating an overview of a motion blur in an image display method of the present embodiment.

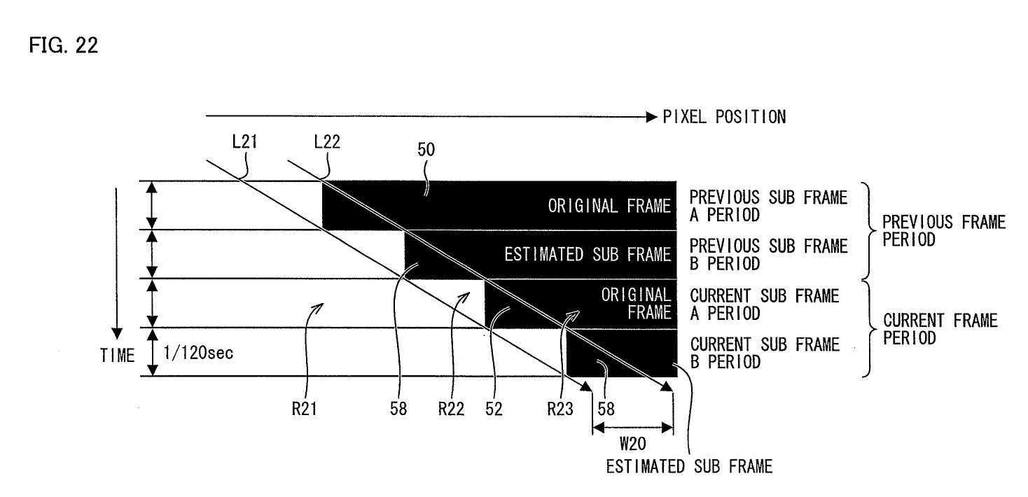

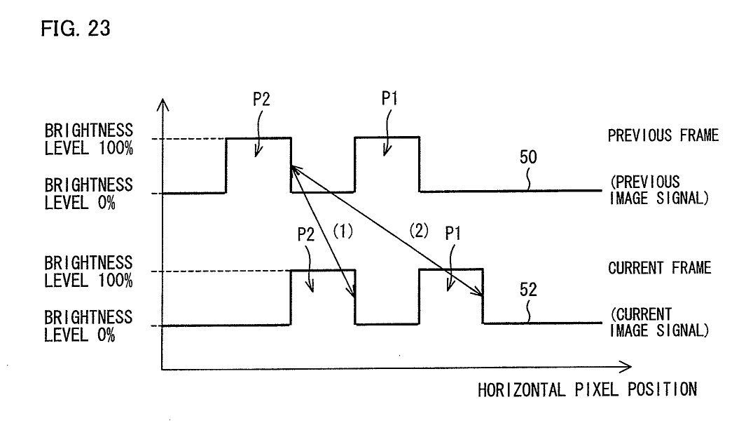

As illustrated in FIG. 1, the image display method of the present embodiment is similar to the image display method using the frame interpolation technique described with reference to FIG. 22, in that a sub frame is provided per frame, and that the display device is driven at 2×.

However, the image signal inputted into the sub frame is different.

Namely, in the frame interpolation technique, the temporally intermediate image signal 58, which is an image signal intermediate of image signals (previous image signal 50, current image signal 52) inputted in two consecutive frames (previous frame, current frame), is inputted into the sub frame. This temporally intermediate image signal 58 is obtained with use of a motion vector, from the image signals inputted into the two consecutive frames, respectively.

In comparison, in the image display method of the present embodiment, an image signal obtained by carrying out a shading process based on (i) the previous image signal 50 which is an image signal inputted into the previous frame and (ii) the current image signal 52 which is an image signal inputted into the current frame, is inputted into the sub frame.

In the embodiment, the shading process denotes a process which reduces a difference between a signal level (brightness level, gray scale level) of a center pixel which is a target pixel of the shading process and that of reference pixels which are pixels positioned around the center pixel.

Further, in carrying out the shading process, the lesser a difference modulus a pixel has as a difference value between the previous image signal 50 and the current image signal 52, the more weight is given as the weighting (specific gravity). Namely, the image signal to be inputted into the sub frame is obtained by carrying out a weighted mean filtering process as the shading process. This is described in details below.

Moreover, in the image processing method of the present embodiment, the shading process can be considered as corresponding to a low-pass filter process.

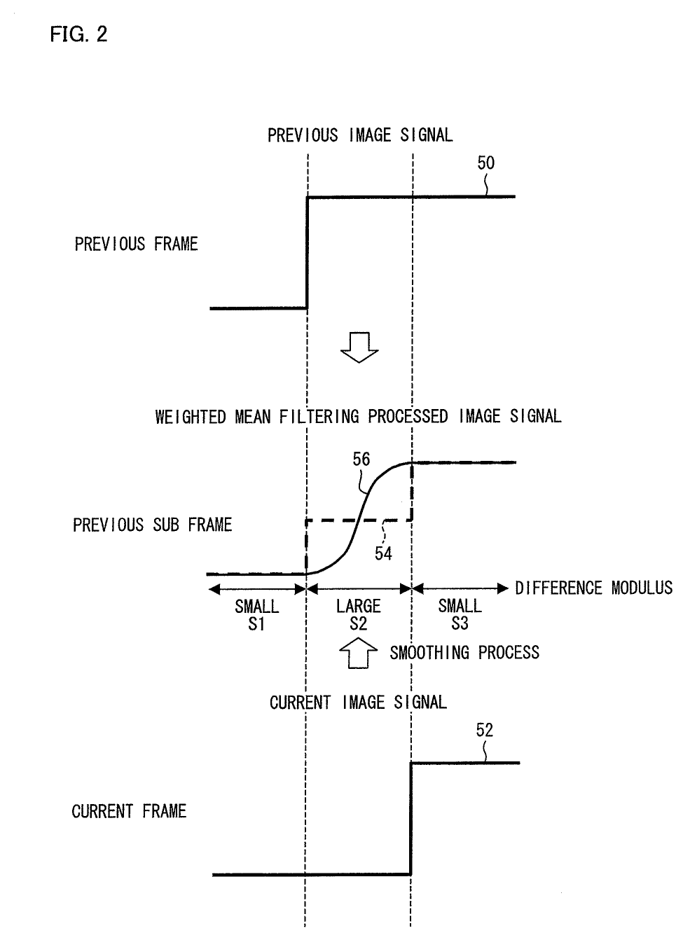

In carrying out the weighted mean filtering process, the lesser the difference modulus of the pixel between the previous image signal 50 and the current image signal 52, the more weight is given as the weighting. The following description explains the image processing method of the present embodiment, with respect to FIG. 2 and the like.

In the image display method of the present embodiment, first, the previous image signal 50 and the current image signal 52 are subjected to a smoothing process, to obtain a smoothed image signal. To this smoothed image signal, the weighted mean filtering process is carried out, to obtain the weighted mean filtering process image signal 56 which is to be inputted into the sub frame.

In the embodiment, the smoothing process is a process for obtaining an image signal which is an intermediate image signal of the previous image signal 50 and the current image signal 52 that are inputted into consecutive two frames, respectively (when a frame rate conversion rate is 2×), and which has a temporally exact gravity position. More specifically, the smoothing process denotes a process of obtaining an image signal in which the signal levels of the previous image signal 50 and current image signal 52 are averaged or weighted and averaged, or denotes a process of obtaining an image signal positioned temporally intermediate of the previous image signal 50 and the current image signal 52.

In a case where the conversion rate of the frame rate is 2×, the smoothing process obtains a sub frame image signal which is positioned temporally intermediate of the entire image and the current image signal. Hence, the averaging process is a simple averaging process. However, in the case of 3×, two sub frame image signals are to be included; in this case, each of the averaged image signals is obtained by weighting and averaging in accordance with a temporal position thereof.

FIG. 2 is a view illustrating an overview of how to obtain the weighted mean filtering process image signal 56.

As illustrated in FIG. 2, in the image display method of the present embodiment, first, the previous image signal 50 and the current image signal 52 are subjected to the averaging process which is one example of the smoothing process, to obtain an averaged image signal 54 as one example of the smoothed image signal. In the embodiment, the averaging process denotes a process in which a brightness level of the previous image signal 50 and a brightness level of the current image signal 52 are averaged to obtain a new image signal.

Next, the weighted mean filtering process is carried out to the obtained average image signal 54. At this time, the lesser a difference modulus of a pixel between the previous image signal 50 and the current image signal 52, the more weight is given.

In the example illustrated in FIG. 2, the difference modulus is small in a first section S1 and a third section S3, and the difference modulus is large in a second section S2. Namely, in the first section 51 and the third section S3, the brightness level of the previous image signal 50 is the same as the brightness level of the current image signal 52. Hence, the difference modulus between the first section S1 and the third section S3 is 0. On the other hand, in the second section S2, the previous image signal 50 has a brightness level of 100 (maximum gray scale level), and the current image signal 52 has a brightness level of 0 (minimum gray scale level). Hence, the difference modulus corresponds to the brightness level of 100.

Hence, in carrying out the weighted mean filtering process, weighting is given more in the first section S1 and the third section S3, whereas the weighting is given less in the second section S2. The weighting is described later.

(Shading Process)

The following description explains the weighted mean filtering process as one example of the shading process, by use of displaying the image illustrated in FIG. 1 as an example.

FIG. 1 is a view illustrating how an edge moves in the present embodiment. In the display example illustrated in FIG. 1, an edge having a sufficiently flat region in a horizontal direction (brightness level of 100% (white) to brightness level of 0% (black)) moves horizontally to the right direction at 16 ppf.

The shading process of the present embodiment (weighted mean filtering process) is characteristic in a point that a filter factor in the shading process is varied in accordance with a difference in brightness level (gray scale level) between the previous image signal 50 that is the image signal of the previous frame and the current image signal 52 that is the image signal of the current frame.

More specifically, in a case where a pixel within a range of the shading process filter has a large difference (difference modulus, current-previous frame difference value) between the current frame and the previous frame, the filter factor is made small, and in a case where the pixel has a small difference, the filter factor is made great.

The following provides specific examples of a case where the shading process is applied to a set pixel (Xcenter, Ycenter: center pixel which is a target pixel of the shading process). The examples may be represented by specific example 1 and specific example 2 below, where a filter factor value θ (x,y) corresponding to a pixel (x, y: coordinates of a pixel arranged to form a matrix) within the filter range in the filter θ of the present embodiment is a current-previous frame difference modulus α (x, y), s shading process filter factor β (x, y), and s threshold value A.

θ(x,y)=factor×(A−α(x,y))×β(x,y) Specific example 1

(where (x, y) is a pixel within the filter, and the factor is a value not less than 0)

θ(x,y)=0, where α>A (factor=0 in the formula of Specific example 1) Specific example 2

θ(x,y)=β, where α≦A (factor=1/(A−α(x,y)) in the formula of Specific example 1)

In Specific example 1, the signal processing amount easily increases. Accordingly, in the present embodiment, Specific example 2 is applied in view that the present image display method is more easily achievable, and the threshold value A is made to be 3% of the maximum signal level.

Moreover, the filter range is a range of 24 pixels in the up-down and left-right directions, in which the set pixel serve as the center. As a result, a square range of 49×49=2410 pixels is to be filtered.

As described above, where a difference (difference value) between the signal level of the previous image signal and the signal level of the current image signal is large is a part where the difference between the signal level of the previous image signal and the signal level of the current image signal is, for example, not less than 3% of the maximum signal level, and where the difference between the signal level of the previous image signal and the signal level of the current image signal is small is a part where the signal level of the previous image signal and the signal level of the current image signal is, for example, less than 3% of the maximum signal level.

Moreover, for instance in a case where the shading process filter factor β is made to be 1 throughout the whole filter range, the weighting of the shading process in the part in which the difference (difference value) between the signal level of the previous image signal and the signal level of the current image signal is large can be determined so that the filter factor value θ is 0, whereas the weighting of the shading process in the part in which the difference between the signal level of the previous image signal and the signal level of the current image signal is small can be determined so that the filter factor value θ is not less than 1 but not more than 256.

(Horizontal Direction)

Next described are the filter θ and its filter factor θ (x, y) ((x, y) is a pixel within the filter range) in a case where just the horizontal direction is considered in the shading process.

Namely, the filter θ of the present embodiment can be represented by the following equation, by use of filter factor θ (x, y) corresponding to the pixel (x, y) within the filter range, where the filter range is a range B pixels left and right from the set pixel (X center, Y center).

θ={θ(Xcenter−B,Ycenter),θ(Xcenter−(B−1),Ycenter), θ(Xcenter−(B−2),Ycenter), . . . ,θ(Xcenter,Ycenter), . . . ,θ(Xcenter+(B−2),Ycenter),θ(Xcenter+(B−1),Ycenter), θ(Xcenter+B,Ycenter)}

(Shading Process Filter Shape)

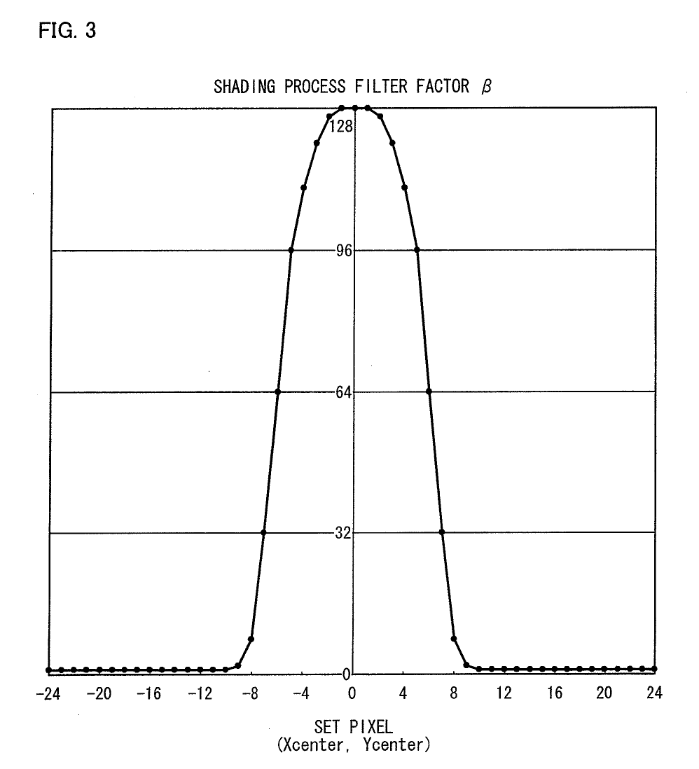

FIG. 3 is a view illustrating a shading process filter shape.

The shading process whose filter shape is illustrated in FIG. 3 is a shading process which just considers the horizontal direction, as described earlier. In FIG. 3, the horizontal axis indicates a position of a pixel, and the vertical axis indicates a shading process filter factor β. Note that FIG. 3 illustrates one example of a process filter shape in a range extending out by 24 pixels in each of the left and right directions from the set pixel (Xcenter, Ycenter), which set pixel serves as a center of the range.

The shading process filter factor β is high at the set pixel and its vicinity parts, and is approximately 128. The shading process filter factor β decreases as the distance from the set pixel furthers away, and at a position approximately 10 pixels away in the left and right directions from the set pixel, the shading process filter factor β is 1. The shading process filter shape of the present embodiment is not limited to what is illustrated in FIG. 3.

For instance, with the shading process which just considers the horizontal direction, it is possible to use a shape different than the shading process filter shape illustrated in FIG. 3.

Moreover, it is possible to carry out the shading process not just based on the horizontal direction but also based on a two-dimensional range which includes the up-down direction.

(Two-Dimensional Range)

The following description deals with an example in which a range of the shading process (shading process range), namely, a range of the reference pixels (reference pixel range) in the shading process is of a two-dimensional range. Generally, the shading process of the present embodiment is preferably calculated by referring to an image signal within a round range whose center is the set pixel. This is because such a range allows for evening the effect of holding down the motion blur against movement in various directions.

However, in general videos such as TV broadcast and movies, more movement are included in the sideways (horizontal) direction than movements in the up-down (vertical) direction, and the movements in the sideways direction are quick. Hence, in the case where the shading process is applied to a TV receiver or the like, it is considered advantageous to have the range of the shading process be wider in the horizontal direction as compared to that in the vertical direction. In this case, it is preferable that the shading process range be an oval shape whose center is the set pixel and whose shape is long in the sideways direction.

Moreover, in a case where the shading process range is made to be a round or an oval range, an arithmetic circuit tends to become a complex configuration, thereby causing an increase in costs. Accordingly, the shading process range may be made as a polygon, such as an octagon or a hexagon whose center is the set pixel. Moreover, by having the shading process range be a rectangular region, it is possible to further simplify the arithmetic circuit.

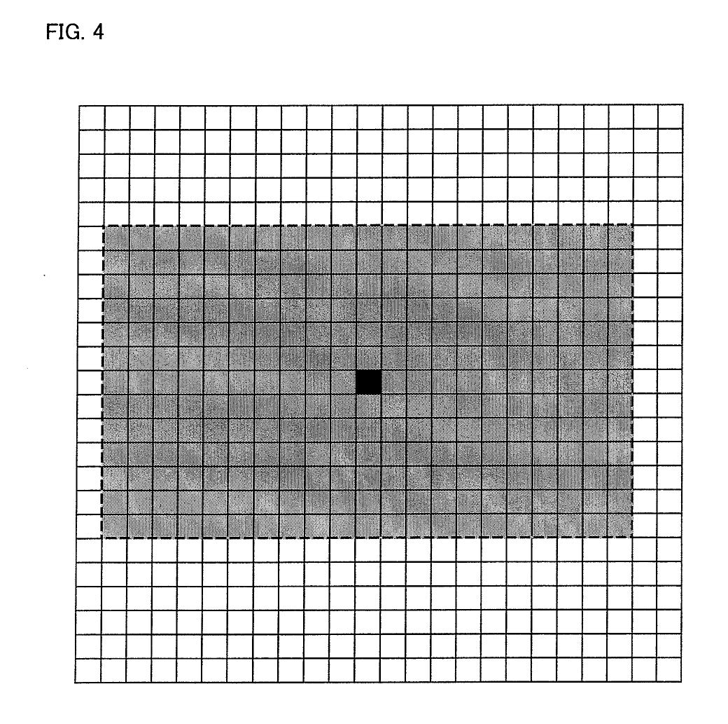

The following describes examples of two-dimensional shading process ranges, with reference to FIG. 4 through FIG. 7.

(Rectangular Region)

FIG. 4 is a view illustrating a rectangular shading process range as one example of the shading process range.

The shading process range illustrated in FIG. 4 is a shading process range of a rectangular region having 13 vertically-adjusted lines of 21 horizontally-aligned pixels whose center is the set pixel. In this example, the shading process carried out to the set pixel is carried out based on image signal values of the pixels within the shading process range, including the set pixel serving as the center.

(Round Region)

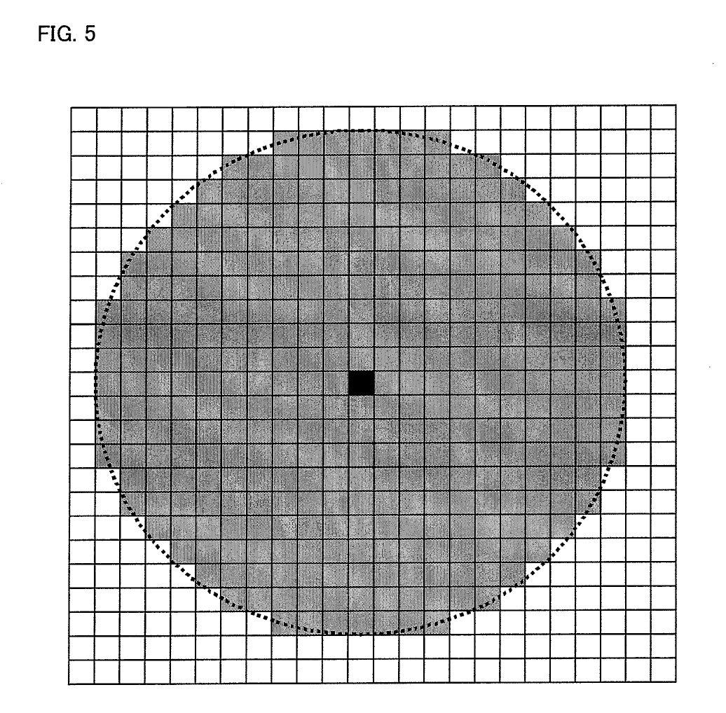

FIG. 5 is a view illustrating a round shaded range as one example of the shading process range.

In the shading process range illustrated in FIG. 5, the shading process range is of a round region including 349 pixels, whose center is the set pixel. In this example also, the shading process carried out to the pixel is carried out based on values of the image signals of the pixels inside the shading process range, including the set pixel.

(Oval Region)

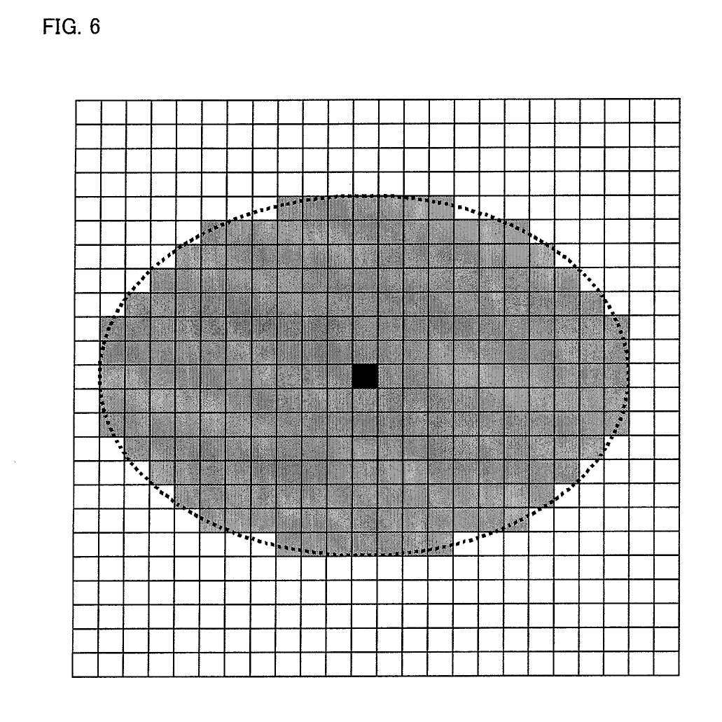

FIG. 6 is a view illustrating an oval shading range as one example of the shading process range.

In the shading process range illustrated in FIG. 6, the shading process range is of an oval region including 247 pixels, whose center is the set pixel. Similarly with the foregoing example, also in this example, the shading process of the set pixel is carried out based on the values of the image signals of the pixels within the shading process range, including the set pixel.

(Hexagonal Region)

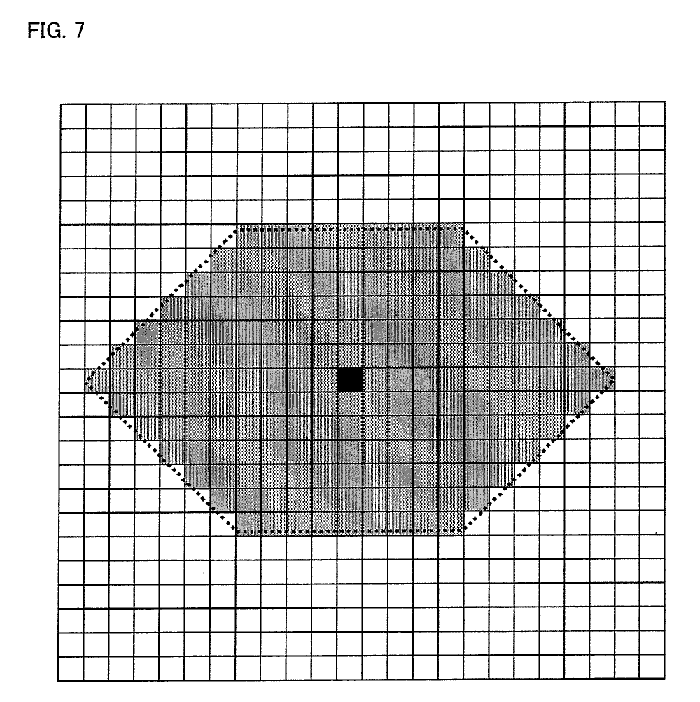

FIG. 7 is a view illustrating a hexagonal shading range, as one example of the shading process range.

The shading process range illustrated in FIG. 7 is a shading process range of a hexagonal region including 189 pixels, whose center is the set pixel.

The hexagon is one example of a polygon, and various polygons other than the hexagon may be applied as the shading process range. Similarly with the foregoing examples, in this example also, the shading process of the set pixel is carried out based on values of image signals of the pixels within the shading process range, including the set pixel.

(Comparison of One-Dimensional and Two-Dimensional)

As described above, the range of the shading process may be just in the horizontal direction (one-dimensional), or may be in the horizontal direction and the vertical direction (two-dimensional).

In a case where the shading process range is just in the horizontal direction, more specifically, is all of one horizontal line whose center is the set pixel, or is a range of one part of the horizontal line, a line memory required would be just of a single line memory. This makes it easy to reduce costs of the image display apparatus.

However, if the shading process range is just in the horizontal direction, the effect of holding down the motion blur is only achieved for images that move in the sideways direction.

In comparison, in the case where the shading process range runs in the horizontal direction and the vertical direction, it is possible to achieve the effect of holding down the motion blur not just for the sideways direction but also for the up-down direction.

The shading process range may extend in any one direction of the vertical direction and the horizontal direction, or may extend in two directions, in the vertical direction and in the horizontal direction. A size (range) of the shading process range is not particularly limited, and is preferably a range having a size of not less than 1% of the screen.

If the range is small, not much of the effect of holding down the motion blur is yielded. However, if the range is increased in size, high-speed calculation is necessarily carried out, since the data amount increases.

On this account, for example by having the range be not less than 1%, it is possible to yield the effect of holding down the motion blur enough that it can be noticed, while holding down the data amount which is targeted for calculation.

Moreover, the shading process range may be, for example, at least a range including “pixels just in the horizontal direction in a range 3% of a horizontal screen length in each of the left and right directions+the set pixel”.

As described above, various settings are possible for the shading process range; for example, the range may include the set pixel, i.e. the pixel targeted for correction, or the range may be one not including the set pixel but including pixels close to the pixel, such as a range not including the set pixel but including pixels adjacent to the set pixel. Moreover, the range may be all pixels in one horizontal line (or one vertical line) in which the set pixel is included, however excluding the set pixel.

In a case where the averaging is carried out, an effect of a similar degree is yielded regardless of whether or not the set pixel is included in the shading process range.

(Brightness Level and Gray Scale Level)

The following description explains the relationship between brightness level and gray scale level. The shading process can be carried out by use of a brightness level of the image signal, as well as by use of a gray scale level of the image signal.

Namely, one method of the shading process is a method in which a gray scale level (gray scale value) of an image signal is used as it is as the value in the shading process, and another method of the shading process is a method in which the gray scale level (gray scale value) is converted into a display brightness level (brightness level (brightness value)) of an image display apparatus, as the value in the shading process.

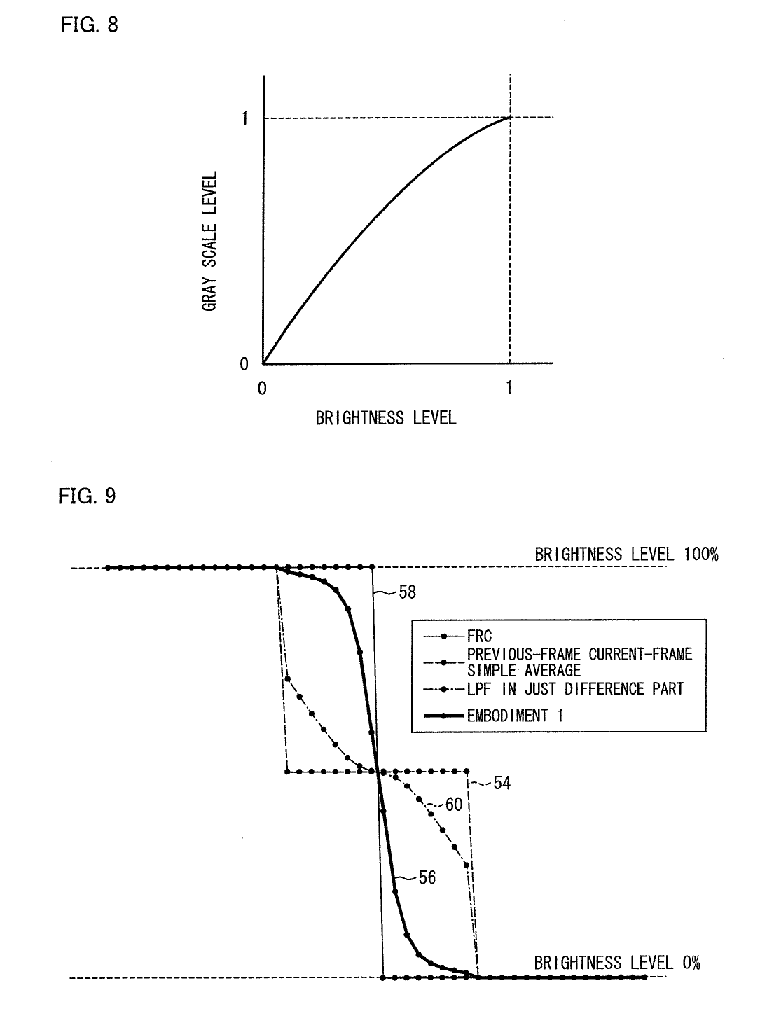

The brightness level and the gray scale level have a relationship as illustrated in FIG. 8. FIG. 8 is a view illustrating a relationship between a brightness level and a gray scale level. More specifically, FIG. 8 is a view illustrating a brightness gray scale characteristic which shows a gray scale level with respect to a display brightness level of an image signal supplied to a general CRT (cathode ray tube). Further, in FIG. 8, the brightness level and the gray scale level are both normalized so that their minimum level is 0 and their maximum level is 1.

In this case, the brightness level is related to the gray scale level as: brightness level=gray scale level to the power of γ (γ≈2.2), as illustrated in FIG. 8.

(Sub Frame Shape)

The following description explains the image signal inputted into the sub frame, in the image display method of the present embodiment.

FIG. 9 is a view illustrating a shape of a weighted mean filtering process image signal 56 in the image display method of the present embodiment.

More specifically, the bold line in FIG. 9 illustrates the weighted mean filtering process image signal 56 of the present embodiment. Moreover, the solid line therein illustrates the temporally intermediate image signal 58 by the frame interpolation technique described earlier. Furthermore, the broken line therein is an averaged image signal (previous-frame current-frame simple average, which is a simple average of (a) a previous image signal 50 which is an image signal of a previous frame and (b) a current image signal 52 which is an image signal of the current frame) 54. Moreover, the alternate long and short dash line therein illustrates a difference section LPF process image signal 60, which is an image signal of a case where a LPF (low-pass filter) process is carried out as the shading process to just the difference section.

(Frame Interpolation Technique)

Before a description is provided of the image signals to be inputted into the sub frame, description is provided with reference to drawings regarding how to obtain the temporally intermediate image signal 58 by the frame interpolation technique, and how to obtain the difference section LPF process image signal 60 of a case where the LPF process is carried out to just the difference section.

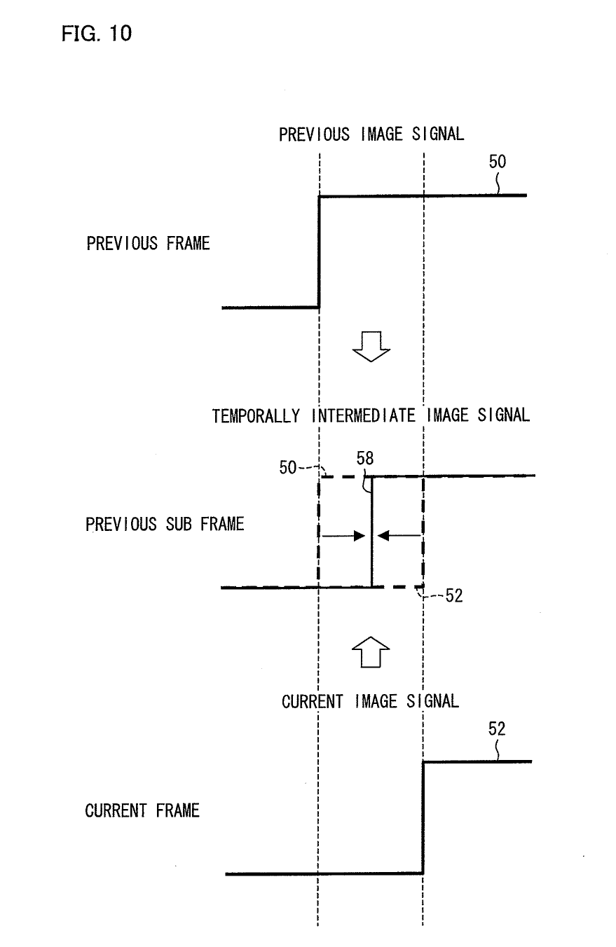

First described is the temporally intermediate image signal 58 of the frame interpolation technique, with respect to FIG. 10. As described above, in the frame interpolation technique, an image signal positioned intermediate of image signals to be respectively inputted into two consecutive frames is estimated, with use of a motion vector.

FIG. 10 is a view illustrating an estimation of the temporally intermediate image signal 58, carried out in the frame interpolation technique. As illustrated in FIG. 10, in the frame interpolation technique, an image signal provided intermediate of a time axis between the previous image signal 50 of the previous frame and the current image signal 52 of the current frame is obtained as the temporally intermediate image signal 58. This temporally intermediate image signal 58 is inputted into the sub frame.

(LPF Process Just to Difference Section)

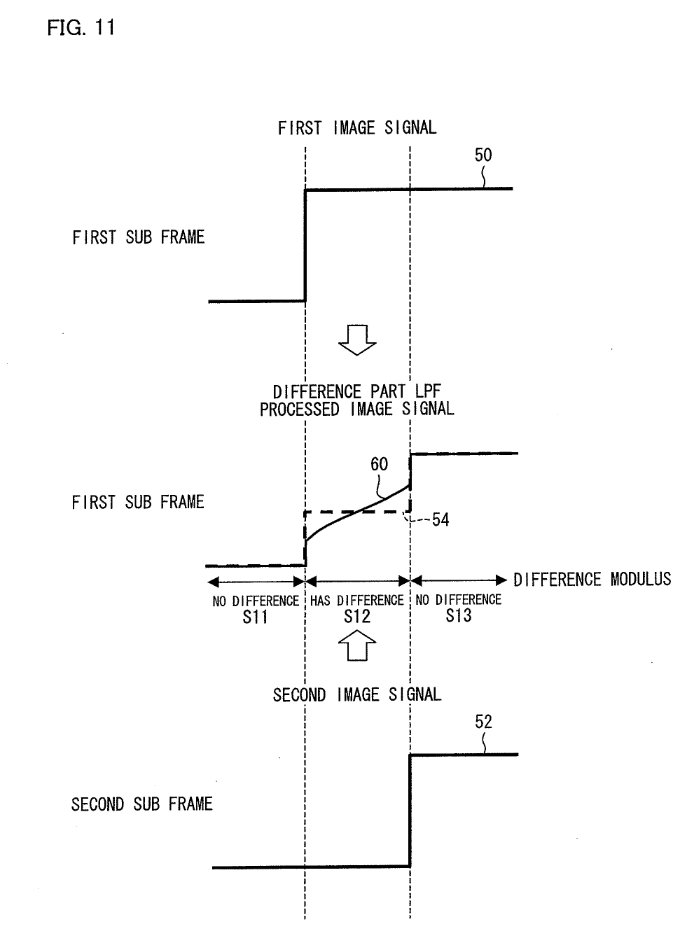

Next described with reference to FIG. 11 is the difference section LPF process image signal 60 which is an image signal inputted into the sub frame in a case where the LPF process is carried out to just the difference section. FIG. 11 is a view illustrating how to obtain the difference section LPF processing image signal 60.

As illustrated in FIG. 11, in a case where the LPF process is carried out to just the difference section, the averaged image signal 54 is first obtained from the previous image signal 50 and the current image signal 52, as with the weighted mean filtering process described with reference to FIG. 2. Thereafter, the LPF process is carried out to this averaged image signal 54.

The LPF process is carried out to the averaged image signal 54 to just the parts having a difference modulus in the brightness level of the previous image signal 50 and in the brightness level of the current image signal 52. Where there is no difference modulus, no LPF process is carried out.

More specifically, the second section S12 illustrated in FIG. 11 has the difference modulus, so the LPF process is carried out to the averaged image signal 54. On the other hand, the first section S11 and the third section S13 illustrated in FIG. 11 do not have the difference modulus, so no LPF process is carried out to the averaged image signal 54.

By carrying out the LPF process to the averaged image signal 54 in just the second section S12, the difference section LPF process image signal 60 is obtained.

How the LPF process is carried out in just the section having the difference modulus (just the difference section), is described in Patent Literature 2.

(Image Signals)

FIG. 9 is a view integrating the image signals inputted into the sub frames, which are obtained as described above. FIG. 9 shows an image signal which is inputted into the sub frame in a case where a range having a brightness level of 100% moves to the left direction of the pixel position with the elapse of time, as illustrated in FIG. 1.

(Visually-Confirmed Edge Shape)

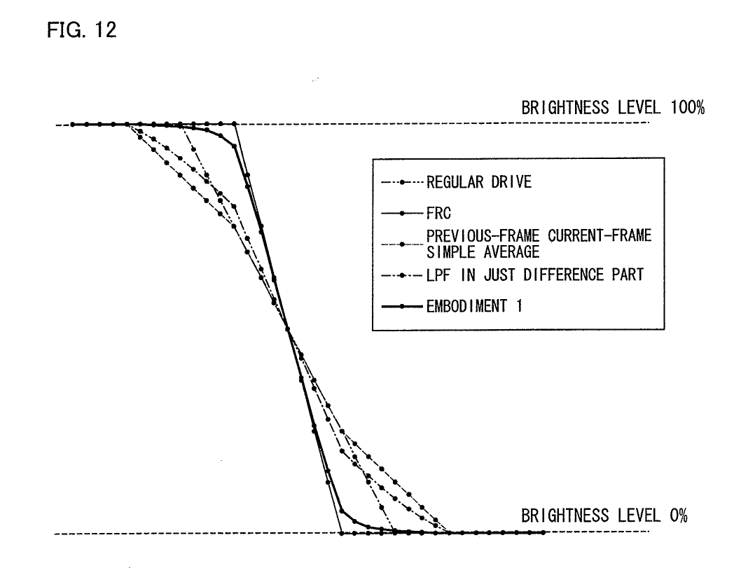

Next described is an edge shape which is visually confirmed by being followed by the eye at a time when the image signals are inputted into the sub frames, with reference to FIG. 12. FIG. 12 is a view illustrating an edge shape visually confirmed while the edge is being followed by the eye.

The following description is of a case where the image display method of the present embodiment is used in a liquid crystal display, and is a simulation result of a case where a response from the liquid crystal is assumed as 0.

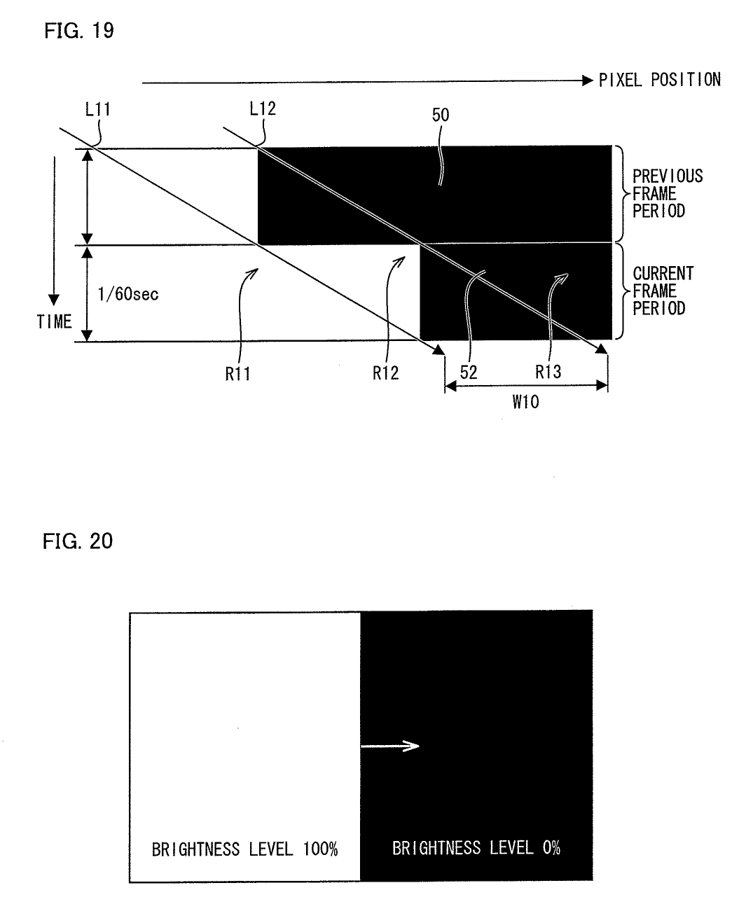

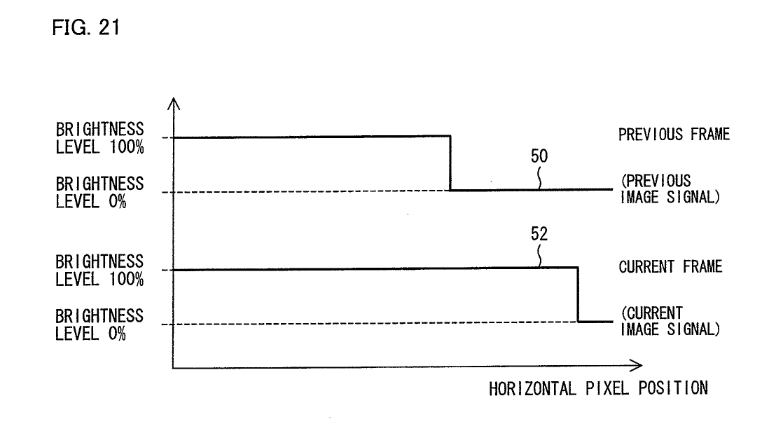

The bold line in FIG. 12 illustrates an edge shape visually confirmed when a weighted mean filtering process image signal 56 of the present embodiment is inputted into the sub frame. Moreover, the solid line therein similarly illustrates an edge shape at the time of inputting the temporally intermediate image signal 58. The broken line therein illustrates an edge shape at a time when an averaged image signal 54 is inputted. Moreover, the alternate long and short dash line therein illustrates an edge shape at a time when the difference section LPF processing image signal 60 is inputted. Moreover, the alternate long and two short dashes line therein illustrates an edge shape in a regular drive described above with reference to FIG. 19. No sub frame is formed for the regular drive.

As illustrated in FIG. 12, the present embodiment and the frame interpolation technique has an inclination from the brightness level 100% to the brightness level 0%, steeper than that of the regular drive. Namely, the present embodiment and frame interpolation technique has the edge shape more clearly visually confirmed than that of the regular drive.

On the other hand, the previous-frame current-frame simple average shows that the inclination from the brightness level of 100% to the brightness level of 0% is either similar to regular drive or is reduced. Namely, in the previous-frame current-frame simple average, the edge shape is recognized similarly to regular drive, or is recognized more unclearly.

Moreover, in a configuration in which LPF is carried out to just the difference section, the inclination from the brightness level of 100% to the brightness level of 0% includes a part in which the inclination is steeper than that of the regular drive and a part in which the inclination is reduced, in a combined manner. More specifically, the inclination is reduced at a part in the vicinity of the brightness level of 100% and at a part in the vicinity of the brightness level of 0%. Hence, as a whole, the configuration in which LPF is just carried out to the difference section has the edge shape that is wider in its motion blur width as compared to that of the regular drive.

The degree of the motion blur is not always determined just by the blur width. For example, even if the blur of the edge is great in the motion blur of ends of the both edges and thus the blur width is wide, there are cases where the appearance thereof is clear for example in a case where the inclination at a center part of the edge is slightly steep.

Hence, in the configuration in which the LPF is carried out just at the difference section, it can be considered in the conditions of the present simulation that the motion blur is reduced as compared to that of the regular drive in an actual display, although the motion blur width is wider than that of the regular drive, as described above.

A comparison of the present embodiment with the frame interpolation technique shows that the frame interpolation technique exhibits a steeper inclination from the brightness level of 100% to the brightness level of 0%. Hence, in the conditions of the present simulation, the frame interpolation technique allows clearer visual confirmation of the edge shape than that of the present embodiment.

However, as described earlier, with the frame interpolation technique, there are cases where an error occurs caused by an estimation error. For instance, the estimation error easily occurs in a case where a killer pattern or the like is inputted, which is a pattern difficult for the motion vector to accurately detect.

In comparison, in the image display method of the present embodiment, no estimation error occurs. Hence, it is possible to hold down the motion blur from occurring, regardless of the image signal to be inputted, without causing any image quality deterioration due to the estimation error.

(Averaged Image Signal)

The following description deals with how to obtain the averaged image signal 54. The averaged image signal 54 as one example of a smoothed image signal in the present embodiment, is obtained from what is called an averaged signal level generation. Consequently, no estimation error occurs.

The averaged signal level generation is to obtain the averaged image signal 54 by calculating an average brightness level of the set pixel, of an image signal of the previous frame and an image signal of the current frame.

Namely, different from what is called temporally intermediate image generation, the averaged signal level generation does not include an estimation process in generating the averaged image signal 54.

Hence, no estimation error which occurs when obtaining the temporally intermediate image signal 58 occurs, in obtaining the averaged image signal 54.

(Entire Configuration)

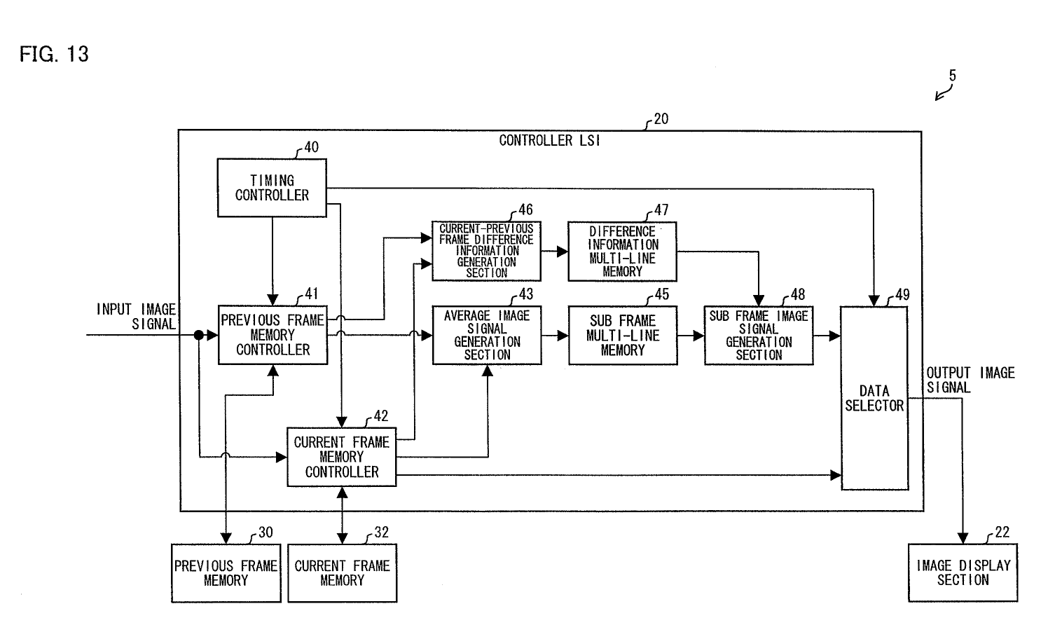

The following description schematically explains a configuration of an image display apparatus 5 of the present embodiment. FIG. 13 is a block diagram schematically illustrating a configuration of the image display apparatus 5 of the present embodiment.

As illustrated in FIG. 13, the image display apparatus 5 of the present embodiment includes an image display section 22 which displays an image, and a controller LSI 20 as a controller for processing image signals inputted into the image display section 22.

More specifically, the image display apparatus 5 is configured in such a manner that the controller LSI 20 is connected to the following: the image display section 22 for example a liquid crystal panel; the previous-frame memory 30; and the current-frame memory 32.

(Controller LSI)

The controller LSI 20 includes a timing controller 40, a previous-frame memory controller 41, a current-frame memory controller 42, an averaged image signal generation section 43, a sub frame multi-line memory 45, a current-previous frame difference information generation section 46, a difference information multi-line memory 47, a sub frame image signal generation section 48, and a data selector 49.

(Timing Controller)

The timing controller 40 generates a timing of a sub frame A period and a timing of a sub frame B period, which periods are generated by time division of an input frame period of 60 Hz, and controls the previous frame memory controller 41, the current frame memory controller 42, and the data selector 49.

(Previous Frame Memory Controller)

The previous frame memory controller 41 carries out the following (1) and (2) in time division, simultaneously: (1) writes in an image signal of 60 Hz of the previous frame (previous image signal 50 of previous frame) into the previous frame memory 30; and (2) successively reads out the previous image signal 50 in line with a timing of the sub frame, which previous image signal 50 is written in the previous frame memory 30 and is a frame image signal one previous of a frame read out by the current frame memory controller 42, and transfers the previous image signal 50 to the averaged image signal generation section 43 and the current-previous frame difference information generation section 46.

(Current Frame Memory Controller)

The current frame memory controller 42 carries out the following (1) and (2) in time division, simultaneously: (1) writes in an image signal of 60 Hz of the current frame (current image signal 52 of the current frame) into the current frame memory 32; and (2) successively reads out the current image signal 52 in line with a timing of the sub frame, which current image signal 52 is written in the current frame memory 32 and is a frame image signal of a frame one subsequent of a frame read out by the previous frame memory controller 41, and transfers the current image signal 52 to the averaged image signal generation section 43 and the current-previous frame difference information generation section 46.

(Averaged Image Signal Generation Section)

At the averaged image signal generation section 43, into which the previous image signal 50 from the previous frame memory controller 41 and the current image signal 52 from the current frame memory controller 42 are inputted, an averaged image signal 54 is generated as a smoothed image signal.

As described above, in the present embodiment, not the temporally intermediate image signal 58, but the averaged image signal 54 which is an average of (a) the brightness or gray scale level of the previous image signal 50 which is an image signal in the previous frame and (b) that of the current image signal 52 which is an image signal in the current frame, is calculated as the smoothed image signal.

This averaged image signal 54 is inputted into the sub frame image signal generation section 48 via the sub frame multi-line memory 45.

(Current-Previous Frame Difference Information Generation Section)

The current-previous frame difference information generation section 46 calculates a difference modulus of brightness levels of (i) the previous image signal 50 from the previous frame memory controller 41 and (ii) the current image signal 52 from the current frame memory controller 42.

As described above, the image display apparatus 5 of the present embodiment changes its weighting in carrying out the shading process, based on the difference modulus of the brightness levels of the previous image signal 50 and the current image signal 52. The current-previous frame difference information generation section 46 calculates the difference modulus which is required at this shading process.

This difference modulus is inputted into the sub frame image signal generation section 48, via the difference information multi-line memory 47.

(Sub Frame Image Signal Generation Section)

The sub frame image signal generation section 48 obtains an image signal which has been subjected to the shading process, to be inputted to the sub frame, from the averaged image signal 54 inputted from the sub frame multi-line memory 45 and the difference modulus inputted from the difference information multi-line memory 47.

As described above, the image display apparatus 5 of the present embodiment carries out the shading process as a weighted mean filtering process. Thereafter, in the sub frame image signal generation section 48, the weighted mean filtering process image signal 56 is obtained as an image signal to be inputted into the sub frame.

(Data Selector)

The data selector 49 outputs the previous image signal 50, the current image signal 52, the weighted mean filtering process signal which is an image signal which has been subjected to the shading process, and like signals, to each of the frames as appropriate, in accordance with the current displayed sub frame phase.

More specifically, the previous image signal 50 is outputted to the previous sub frame A period of the previous frame in FIG. 1, and the weighted mean filtering process signal is outputted to the previous sub frame B period of the previous frame in FIG. 1.

Moreover, the current image signal 52 is outputted to the current sub frame A period of the current frame subsequent to the previous frame.

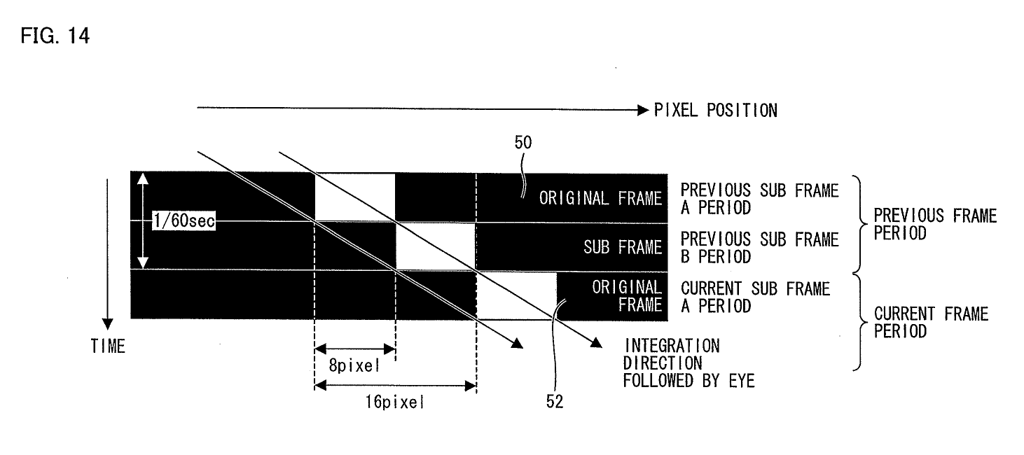

Another embodiment of the image display apparatus 5 of the present invention is described below with reference to FIG. 14 to FIG. 16.

For convenience in description, members having functions identical to those illustrated in the drawings described in Embodiment 1 are provided with identical reference signs, and explanations thereof are omitted in the embodiment.

FIG. 14 is a view illustrating how an edge moves in the image display apparatus 5 of the present embodiment.

The image display apparatus 5 of the present embodiment displays an image different from the image displayed on the image display apparatus 5 of Embodiment 1. As illustrated in FIG. 1, Embodiment 1 illustrates the case where an edge having a sufficiently flat region in the horizontal direction (brightness level of 100% to brightness level of 0%) moves horizontally. On the other hand, the image display apparatus 5 of the present embodiment illustrates a case where an image moves horizontally at 16 ppf in the right direction, which image has a brightness level of 0% with a region of 8 pixels in the horizontal direction having a brightness level of 100% (see FIG. 14).

(Sub Frame Shape)

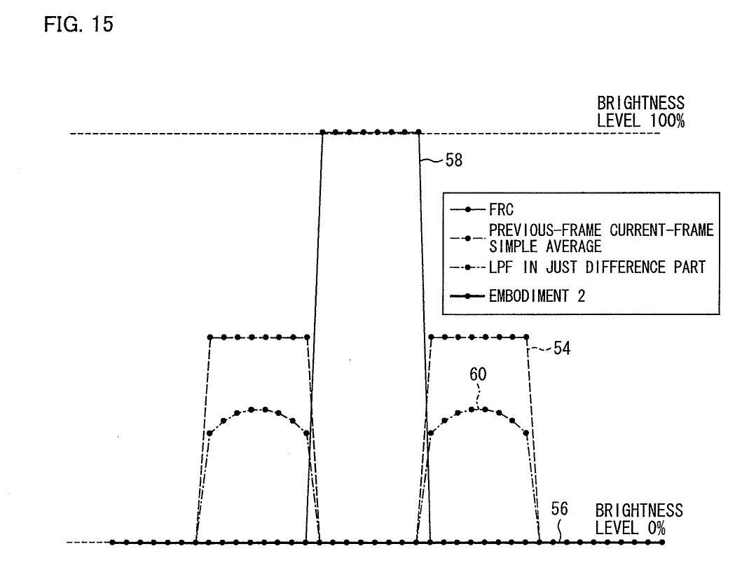

The following description explains an image signal to be inputted into the sub frame in an image display method of the present embodiment, with reference to FIG. 15. FIG. 15 is a view illustrating a shape of the weighted mean filtering process image signal 56 in the present embodiment.

FIG. 15 illustrates other image signals that are to be inputted into the sub frame for comparison, as with FIG. 9 described earlier.

More specifically, the bold line in FIG. 15 illustrates a weighted mean filtering process image signal 56 of the present embodiment. Moreover, the solid line therein illustrates the temporally intermediate image signal 58 of the frame interpolation technique described earlier. The broken line therein illustrates the averaged image signal (previous-frame current-frame simple average, which is a simple average of (a) the previous image signal 50 that is an image signal of the previous frame and (b) the current image signal 52 being an image signal of the current frame) 54. Moreover, the alternate long and short dash line therein illustrates the difference section LPF processing image signal 60 which is an image signal in a case where the LPF processing is carried out to just the difference section.

(Edge Shape)

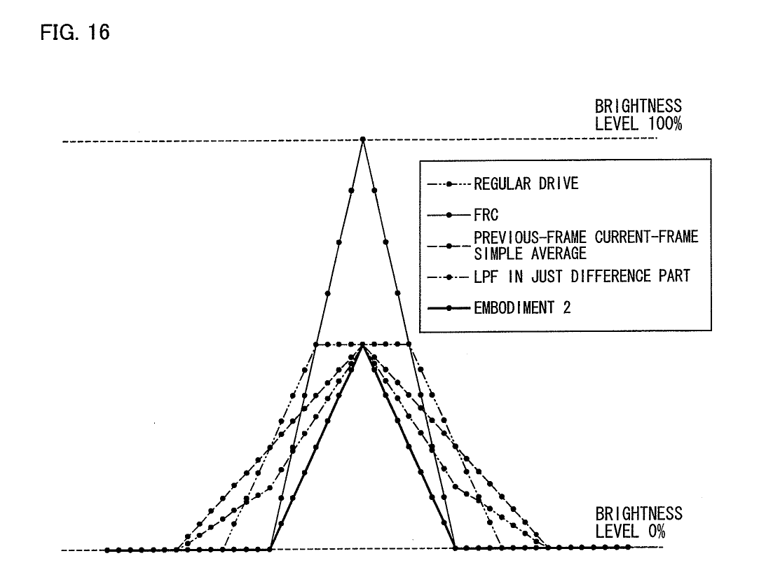

With reference to FIG. 16, the following description deals with an edge shape visually confirmed by following with the eye, in a case where each of the image signals is inputted into the sub frame. FIG. 16 is a view illustrating an edge shape visually confirmed when being followed by the eye.

The following description is of a case where the image display method of the present embodiment is applied to a liquid crystal display device, as with Embodiment 1, and is a simulation result in a case where the response from the liquid crystal is 0.

In FIG. 16, the bold line illustrates an edge shape visually confirmed when the weighted mean filtering process image signal 56 of the present embodiment is inputted into the sub frame. Moreover, the solid line therein similarly illustrates an edge shape of when the temporally intermediate image signal 58 is inputted. The broken line therein illustrates an edge shape of when the averaged image signal 54 is inputted. Moreover, the alternate long and short dash line therein illustrates an edge shape of when the difference section LPF processing image signal 60 is inputted. Further, the alternate long and two short dashes line therein illustrates an edge shape in the regular drive described earlier with reference to FIG. 19. Note that no sub frame is formed during the regular drive.

As illustrated in FIG. 16, the inclination from the brightness level of 100% to the brightness level of 0% is steeper than that in the regular drive, with the frame interpolation technique. Namely, with the frame interpolation technique, the edge shape is visually confirmed clearer than that of the regular drive. However, with the frame interpolation technique, an estimation error may occur as described earlier. Hence, the frame interpolation technique has some practical problems.

In comparison, in the present embodiment, not only does no estimation error occur, but the inclination from the brightness level of 50% to the brightness level of 0% is substantially the same as that of the regular drive. Furthermore, the range of the brightness level of 50% which is the peak of the brightness level is narrower in the present embodiment than that of the regular drive.

Namely, in the present embodiment, no image quality deterioration is caused due to the estimation error, such as image noise, and motion blur is held down as compared to the regular drive.

In the configuration in which the previous-frame current-frame simple average is carried out or that in which LPF at just the difference section is carried out, the inclination from the brightness level of 100% to the brightness level of 0% is reduced as compared to that of the regular drive. Namely, in the configuration in which the previous-frame current-frame simple average is carried out or that in which LPF at just the difference section is carried out, the moving image blur width is broader than that of the regular drive.

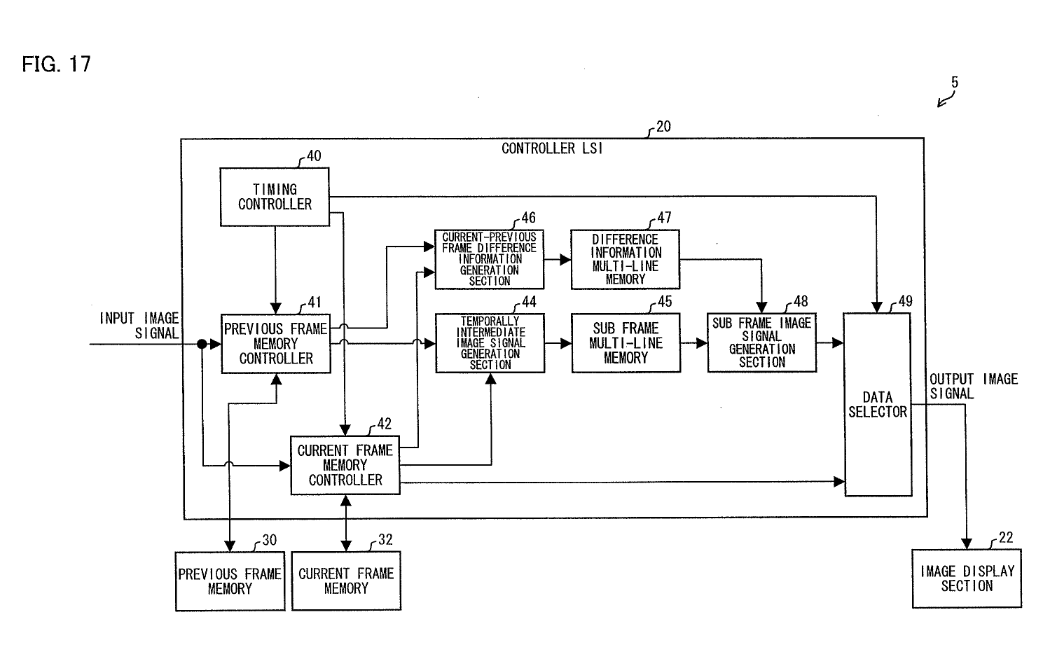

Another embodiment of the image display apparatus 5 of the present invention is described below with reference to FIG. 17 and like drawings.

For convenience in description, members having identical features illustrated in the drawings described in the foregoing embodiments are provided with identical reference signs, and descriptions thereof are omitted here.

FIG. 17 is a view schematically illustrating an image display apparatus of the present embodiment.

The image display apparatus of the present embodiment differs from those of the other embodiments in a point that the smoothed image signal is not the averaged image signal 54 but is the temporally intermediate image signal 58.

That is to say, in the present embodiment, the smoothed image signal which is the target for the shading process is the temporally intermediate image signal 58, whereas the smoothed image signal in the other embodiments is the averaged image signal 54.

Namely, in the present embodiment, the temporally intermediate image signal 58 serving as the smoothed image signal is calculated upon estimation of a frame (virtual sub frame) positioned temporally intermediate of the image signal in the previous frame and the image signal in the current frame, and further estimating an image signal in that virtual sub frame.

Thereafter, the weighted mean filtering process is carried out to the temporally intermediate image signal 58, as the shading process.

In the image display apparatus 5 of the present embodiment, the temporally intermediate image signal generation section 44 is provided instead of the averaged image signal generation section 43 provided in the image display apparatus 5 of the other embodiment described earlier with reference to FIG. 13.

More specifically, the temporally intermediate image signal generation section 44 is disposed in the position of the averaged image signal generation section 43 as illustrated in FIG. 13, so that the previous image signal 50 is inputted from the previous frame memory controller 41, and the current image signal 52 is inputted from the current frame memory controller 42.

The temporally intermediate image signal generation section 44 obtains the temporally intermediate image signal 58 based on the inputted previous image signal 50 and current image signal 52. The obtained temporally intermediate image signal 58 is then inputted into the sub frame image signal generation section 48 from the temporally intermediate image signal generation section 44, via the sub frame multi-line memory 45.

At the sub frame image signal generation section 48, the temporally intermediate image signal 58 is subjected to the shading process by being weighted based on a difference modulus being inputted from the current-previous frame difference information generation section 46 via the difference information multi-line memory 47.

Thereafter, the image signal which has been subjected to the shading process is outputted to the sub frame as with the other embodiments.

(Other Configurations)

The image display method and the image display apparatus, each of the present invention, is not limited to the methods and configurations described in the embodiment; various modifications may be made to these methods and configurations.

(Shading Process with Respect to Difference Modulus)

For instance, in the foregoing embodiment, weighting is changed in accordance with a value of the difference modulus of the previous image signal 50 and the current image signal 52, in carrying out the shading process of the smoothed image signal.

Determination of the weight in the weighting is not limited to determining the weight in accordance with the difference modulus itself, and may be determined upon carrying out the shading process or the like to the difference modulus and determining the weighting in accordance with a value obtained by the process. This is described below with reference to drawings.

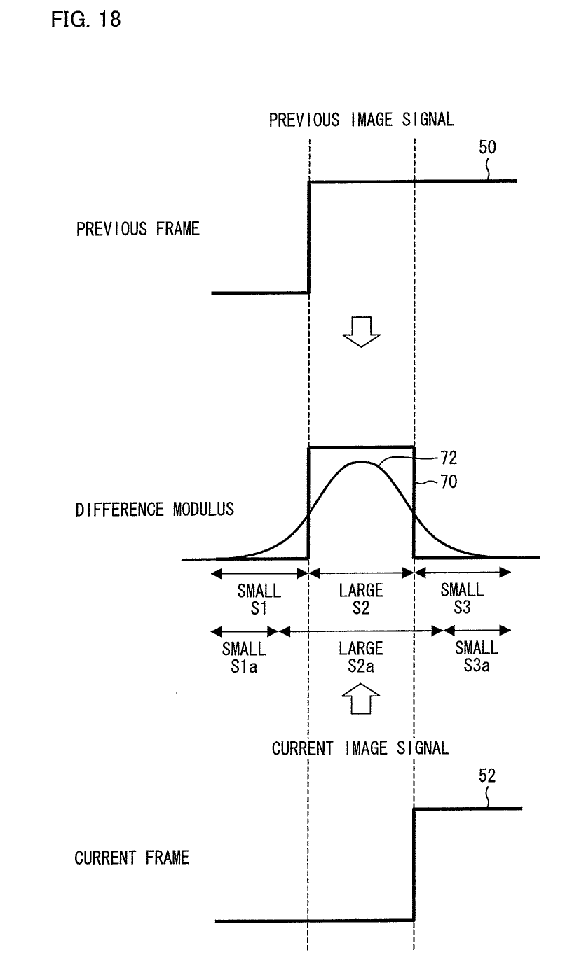

FIG. 18 is a view illustrating a difference modulus and an example of a process carried out to the difference modulus.

In the example illustrated in FIG. 18, the difference modulus (unprocessed difference modulus 70) of (a) the previous image signal 50 being the image signal of the previous frame and (b) the current image signal 52 being the image signal of the current frame is of a rectangular shape.

Carrying out the shading process to the unprocessed difference modulus 70 obtains a curved shading-processed difference modulus 72.

The weighting in the shading process of the smoothed image signal may be determined based on the unprocessed difference modulus 70, or may be determined based on the shading-processed difference modulus 72.

In the case where the weighting is determined based on the unprocessed difference modulus 70, for example, the first section S1 and the third section S3 are determined as sections having a small difference modulus, thereby the weighting thereof becoming high, whereas the second section S2 is determined as a section having a large difference modulus, thereby the weighting thereof becoming low (as described earlier).

In comparison, in a case where the weighting is determined based on the shading-processed difference modulus 72, the processed first section S1a and the processed third section S3a are determined as the sections having the small difference modulus, and the weighting thereof becomes high. Moreover, the processed second section S2a is determined as a section having the large difference modulus, thereby the weighting thereof becoming low.

By determining the weighting in accordance with the difference modulus which has been subjected to the shading process and the like as described above, it is possible to change the section to which the weighting is determined to any section.

Strength of processes such as the shading filter factor and the like in carrying out the shading process to the difference modulus (unprocessed difference modulus 70) is not particularly limited, and the difference modulus may be processed by any factors and the like.

(Shading Process to Just the Difference)

Moreover, in carrying out the shading to the process image signal (smoothed image signal), the example described in FIG. 2, FIG. 18 and the like have the weighting determined as low in the sections where the difference modulus is large, and have the weighting determined as high in sections where the difference modulus is small, with respect to the difference modulus of the previous image signal 50 and the current image signal 52.

The weighting in carrying out the shading process to the smoothed image signal in the present invention is not limited to the aforementioned methods.

For instance, with the sections shown in FIG. 18, the shading process may be carried out to the smoothed image signal just in the second sections S2 and S2a which are sections having a large difference modulus, and no shading process may be carried out to the smoothed image signal in the first sections S1 and S1a and third sections S3 and S3a, which are sections having a small difference modulus.

The present invention is not limited to the description of the embodiments above, but may be altered by a skilled person within the scope of the claims. An embodiment based on a proper combination of technical means disclosed in different embodiments is encompassed in the technical scope of the present invention.

Moreover, the image display method of the present invention is configured in such a manner that in the shading process, the weighting of the shading process is low for a section in which the difference between the signal level of the previous image signal and the signal level of the current image signal is large, and the weighting of the shading process is high for a section in which the difference between the signal level of the previous image signal and the signal level of the current image signal is small.

According to the method, the shaded image signal obtained by the shading process easily serves as a signal suitable for narrowing a motion blur width which occurs when being followed by the eye.

Namely, in order to narrow the motion blur width, it is preferable that an image signal provided temporally intermediate between the previous image signal and a current image signal be outputted to a sub frame period. Related to this, the shaded image signal to which such a weighting is determined becomes close to the image signal in the temporally intermediate position.

Hence, according to the method, this allows for more easily holding down the occurrence of the motion blur.

Moreover, the image display method of the present invention is configured in such a manner that in carrying out the shading process, the shading process is carried out just at a section in which the signal level of the previous image signal differs from the signal level of the current image signal.

According to the method, the shading process is carried out to just the sections which have a difference between a signal level of the previous image signal and a signal level of the current image signal. Hence, it is possible to easily hold down the occurrence of the motion blur.

There is no need to calculate a temporally intermediate position for a part having no difference between the signal level of the previous image signal and that of the current image signal, i.e., a part having no movement as a video image. Accordingly, by carrying out the shading process in just the difference section or just when a difference value is not less than a certain value (e.g., not less than 3% of a maximum signal level), it is possible to hold down the occurrence of the motion blur more appropriately.

Moreover, the image display method of the present invention further includes: carrying out a smoothing process of the previous image signal and the current image signal, to obtain a smoothed image signal; and carrying out a shading process to the smoothed image signal, to obtain the shaded image signal.

According to the method, the shaded image signal is obtained by the shading process based on a smoothed image signal which is an image signal having been subjected to a smoothing process.

Hence, it is possible to obtain the shaded image signal capable of narrowing a blur width, more accurately. More specifically, it becomes easier to obtain an image signal close to an image signal for example provided temporally intermediate between the previous image signal and the current image signal.

Moreover, the image display method of the present invention is configured in such a manner that the smoothed image signal is an averaged image signal obtained by averaging or calculating a weighted mean of the signal level of the previous image signal and the signal level of the current image signal.

According to the method, the smoothed image signal is an averaged image signal obtained by averaging or calculating a weighted mean of (i) a signal level of the previous image signal and (ii) a signal level of the current image signal.

For this reason, no estimation process is included in processes for obtaining the average image. Hence, no image signal which includes an error caused by an estimation error is outputted to the sub frame period.

Hence, it is possible to hold down the occurrence of the motion blur without causing any image quality deterioration such as an image error due to the estimation error.

Moreover, the image display method of the present invention is configured in such a manner that the smoothed image signal is a temporally intermediate image signal obtained by estimating an image signal provided temporally intermediate of the previous image signal and the current image signal.

According to the method, the smoothed image signal is a temporally intermediate image signal obtained by estimating an image signal that is provided temporally intermediate between the previous image signal and the current image signal. This may cause an error due to an estimation error. In this case, the shading process may at times reduce the degree of deterioration in image quality such as image noise, which is caused by the error.

Moreover, the image display method of the present invention is configured in such a manner that the shading process is a process for reducing a difference between a signal level of a target pixel targeted for the shading process and a signal level of a reference pixel being at least one pixel positioned around the target pixel.

According to the method, the shading process is carried out so that a difference between the signal level of the target pixel and that of the reference pixel is made small. Hence, it is possible to further hold down the occurrence of the motion blur.

Moreover, the image display method of the present invention is configured in such a manner that the shading process is a low-pass filter process.

According to the method, the shading process is a low-pass filter process. Hence, it is possible to carry out a process substantially corresponding to the shading process.

Moreover, the image display method of the present invention is configured in such a manner that the target pixel is included within a range of the reference pixel.

According to the method, the target pixel is included inside the range of the reference pixel. Hence, it is possible to carry out a more preferable shading process.

Moreover, even if the target pixel is not included in the range of the reference pixel, it is possible to yield an effect of substantially a same degree.

Moreover, the image display method of the present invention is configured in such a manner that the reference pixel forms a range serving as a part of a horizontal line or a whole of a horizontal line, whose center of the horizontal line is the target pixel.

According to the method, the range of the reference pixel is a part or a whole of one horizontal line whose center is the target pixel. Accordingly, just a single line memory is read to carry out the correcting process. Hence, it is possible to hold down the increase in manufacturing cost.

Moreover, the image display method of the present invention is configured in such a manner that the reference pixel forms a range which is a round range whose center is the target pixel.

According to the method, the range of the reference pixel is of a round range whose center is the target pixel. Hence, it is easy to prevent the motion blur of movement made in various directions.

Moreover, the image display method of the present invention is configured in such a manner that the reference pixel forms a range which is an oval range whose center is the target pixel.

According to the method, the range of the reference pixel is of an oval range whose center is the target pixel. Hence, it is possible to suitably use the method with general images which move more in the sideways (horizontal) direction than in the up-down (vertical) direction and which move quickly, such as TV broadcast and movies, while yielding the effect of holding down the motion blur in uniform manner in various directions.

Moreover, the image display method of the present invention is configured in such a manner that the reference pixel forms a range which is a polygonal range whose center is the target pixel.

According to the method, the range of the reference pixels is of a polygonal range whose center is target pixel. Hence, it is possible to simplify an arithmetic circuit configuration by which manufacturing costs can be held down while yielding the effect of holding down the motion blur in uniform manner in various directions, as compared to the round or oval range of the target pixel.

Moreover, the image display method of the present invention is configured in such a manner that the reference pixel forms a range which is a rectangular range whose center is the target pixel.

According to the method, the range of the reference pixel is of a rectangular region whose center is the target pixel. Hence, it is possible to more simplify an arithmetic circuit configuration by which manufacturing costs can be held down while yielding the effect of holding down the motion blur in uniform manner in various directions, as compared to a round, an oval, or a polygonal range other than a rectangular shape, as the range of the target pixel.

Moreover, the image display method of the present invention is configured in such a manner that the reference pixel forms a range having a size of not less than 1% of a size of the screen in at least one direction of the screen in the vertical direction and horizontal direction.

According to the method, the range of the reference pixel is a range of a size not less than 1% of a size of the screen in any one of a vertical and a horizontal direction thereof, or of both directions. Hence, it becomes easy to yield an effect that can be realized while holding down an amount of data to be calculated.

Moreover, the image display method of the present invention is configured in such a manner that the reference pixel forms a range wider in a horizontal direction of the screen than in a vertical direction of the screen.

According to the method, the range of the reference pixel is wider in the horizontal direction than in the vertical direction. Hence, the method handles movements more suitably in the sideways direction often occurring with general images such as television broadcast, and thus can improve the motion blur of such general images.

Moreover, the image display method of the present invention is configured in such a manner that the signal level is a brightness level.

According to the method, the signal level is a brightness level. Hence, it is possible to effectively improve the motion blur.

Moreover, the image display method of the present invention is configured in such a manner that the signal level is a gray scale level.

According to the method, the signal level is a gray scale level. Hence, it is possible to hold down the increase in manufacturing costs.

Moreover, the image display method of the present invention wherein the weighting of the shading process in accordance with the signal level of the previous image signal and the signal level of the current image signal is changed by: calculating a difference value indicative of the difference between the signal level of the previous image signal and the signal level of the current image signal; carrying out a shading process to the difference value; and changing the weighting of the shading process based on the difference value to which the shading process is carried out.

According to the method, the weighting of the shading process is determined based on a value to which the shading process is carried out to a difference value which is a difference between a signal level of the previous image signal and a signal level between the current image signal.

Moreover, the image display method of the present invention is configured in such a manner that the pixels are arranged on the screen so as to form a matrix, and θ(x,y)=K×(A−α(x,y))×β(x,y), where θ is a filter factor value as the weighting of the shading process, (x,y) is a coordinate of a pixel targeted for the shading process among the pixels, K is a coefficient of the shading process, A is a threshold value of the shading process, α is a difference value between the signal level of the previous image signal and the signal level of the current image signal of the shading process, and β is a shading process filter factor of the shading process, the difference value α being indicated by a difference between (a) the signal level of the previous image signal with respect to a maximum signal level and (b) the signal level of the current image signal with respect to the maximum signal level, the section in which the difference between the signal level of the previous image signal and the signal level of the current image signal is large being a section in which the difference α is not less than the threshold value A, and the section in which the difference between the signal level of the previous image signal and the signal level of the current image signal is small being a section in which the difference α is less than the threshold value A.

Moreover, the image display method of the present invention is configured in such a manner that the filter factor value θ in the section in which the difference between the signal level of the previous image signal and the signal level of the current image signal is large is 0, and the filter factor θ in the section in which the difference between the signal level of the previous image signal and the signal level of the current image signal is small is not less than 1 but not more than 256, where the threshold value A is 3% of the maximum signal level, and the shading process filter factor β is 1 in an entire filter range.

According to the method, it is possible to further hold down the occurrence of motion blur.

An image display apparatus of the present invention is suitably used in liquid crystal television receivers and the like which frequently display video images, since the motion blur is high.

### REFERENCE SIGNS LIST

5 image display apparatus
20 controller LSI (controller)
50 previous image signal
52 current image signal
54 averaged image signal (smoothed image signal)
56 weighted mean filtering process image signal (shaded image signal)
58 temporally intermediate image signal (smoothed image signal)
60 difference section LPF processing image signal
70 unprocessed difference modulus
72 shading-processed difference modulus

1. A method of displaying an image on a screen in which a plurality of pixels are arranged, the image being displayed on the screen by the pixels of the screen receiving an image signal per frame period, the frame period being a period required for the pixels of one screen to receive the image signal,
the method comprising:
obtaining a shaded image signal by carrying out a shading process based on a previous image signal and a current image signal, the previous image signal being an image signal inputted into a previous frame period and the current image signal being an image signal inputted into a current frame period, the previous frame period and the current frame period being two consecutive frame periods;
changing a weighting of the shading process in carrying out the shading process, in accordance with a difference between a signal level of the previous image signal and a signal level of the current image signal;
dividing the previous frame period to provide a sub frame period; and
outputting the shaded image signal to the sub frame period.

2. The image display method according to claim 1, wherein in the shading process,
the weighting of the shading process is low for a section in which the difference between the signal level of the previous image signal and the signal level of the current image signal is large, and
the weighting of the shading process is high for a section in which the difference between the signal level of the previous image signal and the signal level of the current image signal is small.

3. The image display method according to claim 1, wherein in carrying out the shading process,
the shading process is carried out just at a section in which the signal level of the previous image signal differs from the signal level of the current image signal.

4. The image display method according to claim 1, further comprising:
carrying out a smoothing process of the previous image signal and the current image signal, to obtain a smoothed image signal; and
carrying out a shading process to the smoothed image signal, to obtain the shaded image signal.

5. The image display method according to claim 4, wherein the smoothed image signal is an averaged image signal obtained by averaging or calculating a weighted mean of the signal level of the previous image signal and the signal level of the current image signal.

6. The image display method according to claim 4, wherein the smoothed image signal is a temporally intermediate image signal obtained by estimating an image signal provided temporally intermediate of the previous image signal and the current image signal.

7. The image display method according to claim 1, wherein the shading process is a process for reducing a difference between a signal level of a target pixel targeted for the shading process and a signal level of a reference pixel being at least one pixel positioned around the target pixel.

8. The image display method according to claim 7, wherein the shading process is a low-pass filter process.

9. The image display method according to claim 7, wherein the target pixel is included within a range of the reference pixel.

10. The image display method according to claim 7, wherein the reference pixel forms a range serving as a part of a horizontal line or a whole of a horizontal line, whose center of the horizontal line is the target pixel.

11. The image display method according to claim 7, wherein the reference pixel forms a range which is a round range whose center is the target pixel.

12. The image display method according to 7, wherein the reference pixel forms a range which is an oval range whose center is the target pixel.

13. The image display method according to claim 7, wherein the reference pixel forms a range which is a polygonal range whose center is the target pixel.

14. The image display method according to claim 7, wherein the reference pixel forms a range which is a rectangular range whose center is the target pixel.

15. The image display method according to claim 7, wherein the reference pixel forms a range having a size not less than 1% of a size of the screen in at least one direction of the screen in the vertical direction and horizontal direction.

16. The image display method according to claim 7, wherein the reference pixel forms a range wider in a horizontal direction of the screen than in a vertical direction of the screen.

17. The image display method according to claim 1, wherein the signal level is a brightness level.

18. The image display method according to any one of claim 1, wherein the signal level is a gray scale level.

19. The image display method according to claim 1, wherein the weighting of the shading process in accordance with the signal level of the previous image signal and the signal level of the current image signal is changed by:
calculating a difference value indicative of the difference between the signal level of the previous image signal and the signal level of the current image signal;
carrying out a shading process to the difference value; and
changing the weighting of the shading process based on the difference value to which the shading process is carried out.

20. The image display method according to claim 2, wherein
the pixels are arranged on the screen so as to form a matrix, and
θ(x,y)=K×(A−α(x,y))×β(x,y),
where θ is a filter factor value as the weighting of the shading process, (x,y) is a coordinate of a pixel targeted for the shading process among the pixels, K is a coefficient of the shading process, A is a threshold value of the shading process, α is a difference value between the signal level of the previous image signal and the signal level of the current image signal of the shading process, and β is a shading process filter factor of the shading process,
the difference value α being indicated by a difference between (a) the signal level of the previous image signal with respect to a maximum signal level and (b) the signal level of the current image signal with respect to the maximum signal level,
the section in which the difference between the signal level of the previous image signal and the signal level of the current image signal is large being a section in which the difference a is not less than the threshold value A, and
the section in which the difference between the signal level of the previous image signal and the signal level of the current image signal is small being a section in which the difference a is less than the threshold value A.

21. The image display method according to claim 20, wherein
the filter factor value θ in the section in which the difference between the signal level of the previous image signal and the signal level of the current image signal is large is 0, and
the filter factor θ in the section in which the difference between the signal level of the previous image signal and the signal level of the current image signal is small is not less than 1 but not more than 256,
where the threshold value A is 3% of the maximum signal level, and the shading process filter factor β is 1 in an entire filter range.

22. An image display apparatus comprising:
a screen in which a plurality of pixels are arranged, displaying an image by receiving an image signal at the pixels per frame period, the frame period being a period required for the pixels of one screen to receive an image signal; and
a controller controlling the image signal,
the controller (i) obtaining a shaded image signal by carrying out a shading process based on a previous image signal and a current image signal, the previous image signal being an image signal inputted into a previous frame period and the current image signal being an image signal inputted into a current frame period, the previous frame period and the current frame period being two consecutive frame periods, (ii) changing a weighting of the shading process in carrying out the shading process, in accordance with a difference between a signal level of the previous image signal and a signal level of the current image signal, (iii) dividing the previous frame period to provide a sub frame period, and (iv) outputting the shaded image signal to the sub frame period
